(19) United States
(12) Patent Application Publication
(10) Pub. No.: US 2008/0012723 A1
(43) Pub. Date: Jan. 17, 2008

(54) REMOTE CONTROLLER

(75) Inventor: Yung-Hui Wang, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATEN WIRELESS TECHNOLOGY INC., Taipei City (TW)

(21) Appl. No.: 11/308,165

(22) Filed: Mar. 9, 2006

(51) Int. Cl. G08C 19/00

(52) U.S. Cl. 340/825.72; 340/825.25

(57) ABSTRACT

A remote controller capable of outputting audio frequency signals is provided. The remote controller comprises a control circuit, a digital/analog converter and a wireless receiver/transmitter. The wireless receiver/transmitter is adopted for receiving audio frequency signals generated from an electronic device, and the control circuit is connected to the wireless receiver/transmitter and the digital/analog converter respectively and is adopted for outputting and transmitting the audio frequency signals to a sound output device connected to the remote controller. Thus, the audio frequency signals generated by the electronic device can be received by the remote controller within an effective range and output by the sound output device. Accordingly, the overall cost can be reduced and the remote controller of the present invention can be more attractive to the users.

### BACKGROUND OF INVENTION

1. Field of the Invention

The present invention generally relates to a remote controller, and more particularly to a remote controller capable of receiving and outputting audio frequency signals generated by electronic devices.

2. Description of Related Art

The number of the remote controllers of conventional home electronic products has increased along with increasing number of electronic devices. For providing more convenience, various types of remote controllers have been invented for making the best use of the electronic devices. With the advent of information appliance (IA) era, multi-functional remote controllers have developed to capable of not only controlling a single electronic device but a plurality of electronic devices. However, so far, the remote controllers function using only signal transmission without any other functions.

Furthermore, because many electronic devices can be remotely controlled, the remote controlling function cannot satisfy the modern users. For providing the users more convenience, some manufacturers invented a remote controller device for notebook computer, which can function both as a remote controller and a mouse. Although this invention provides more convenience to users, but there are still more improvement available which can provide comparatively more convenience to users.

Generally, a home comprises a living room, a kitchen, a bedroom and the like. In order to listen to music in every corners of the home, an electronic device is required in each and every room or the volume has to be turned loud. However, using several electronic devices is very expensive and increasing the volume of the music may disturb the peace.

Besides, most of the electronic devices have to be connected to either earphones or speakers, and the position of the electronic devices must be fixed. For resolving the abovementioned defects, MD, MP3 and other similar portable devices have been developed. Although these portable electronic devices are much lighter, thinner, shorter and smaller but the functions of such electronic devices are limited to play the media with certain types of specific formats.

Therefore, how to overcome the above defects of the conventional art is an important issue for the manufacturers in the field.

### SUMMARY OF THE INVENTION

According to an aspect of the present invention, the remote controller comprises a control circuit, a digital/analog converter and a wireless receiver/transmitter. The wireless receiver/transmitter is adopted for receiving audio frequency signals generated from an electronic device, and the control circuit is connected to the wireless receiver/transmitter and the digital/analog converter respectively and is adopted for outputting the audio frequency signals via a sound output device connected to the remote controller. Thus, the audio frequency signals generated from the electronic device can be received by the remote controller within an effective range and output by the sound output device. Accordingly, the overall cost can be reduced and the remote controller of the present invention can be more attractive to the users.

According to another aspect of the present invention, the wireless receiver/transmitter of the remote controller may be adopted for emitting a connection signal to the electronic device to enable the electronic device determine the audio frequency signals and transmit to the remote controller via the wireless receiver/transmitter. Thus, the audio frequency signals can be output by the remote controller via the sound output device without being directly connected to the electronic device. Thus, the disadvantages of several electronic devices in every corners of the home or turning the sound volume very loud can be effectively reduced.

### BRIEF DESCRIPTION OF THE DRAWING

FIG. 1 is a block diagram of a remote controller according to an embodiment of the present invention.

FIG. 2 is a block diagram of a remote controller according to another embodiment of the present invention.

### DETAILED DESCRIPTION OF THE INVENTION

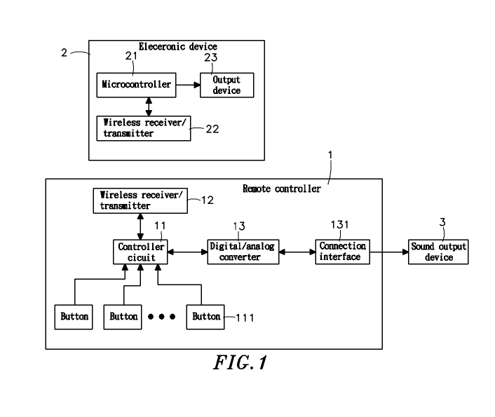

Referring to FIG. 1, a remote controller 1 of the present invention comprises a controller circuit 11, a wireless receiver/transmitter 12 and a digital/analog converter 13.

The controller 11 is electrically connected to a plurality of buttons 111, and a user may press the buttons 111 to generate and transmit a control signal to the control circuit 11.

The wireless receiver/transmitter 12 is electrically connected to the control circuit 11 and is adopted for transmitting the control signal generated by the buttons 111 to a wireless receiver/transmitter 22 of an electronic device 2.

The digital/analog converter 13 is electrically connected to the control circuit 11 and a connection interface 131 for connecting to a sound output device 3.

When the remote controller 1 is connected to the sound output device 3, the control circuit 11 emits a connection signal to the electronic device 2 via the wireless receiver/transmitter 12 to enable the electronic device 2 to continuously transmit audio frequency signals to the wireless receiver/transmitter 12 of the remote controller 1 via the wireless receiver/transmitter 22, and the wireless receiver/transmitter 12 transmits the audio frequency signals to the digital/analog converter 13 via the control circuit 11 for converting the audio frequency signals into analog signals which are then outputted via the sound output device 3. Thus, the audio frequency signals generated by the electronic device 2 can be received by the remote controller 1 within an effective range and outputted via the sound output devices 3. Furthermore, the sound output device 3 can be plural.

Furthermore, when the control circuit 11 senses that the sound output device 3 is disconnected from the connection interface 131, the control circuit 11 transmits a disconnected signal to the electronic device 2 via the wireless receiver/transmitter 12 to stop the electronic device 2 from emitting the audio frequency signals.

When the wireless receiver/transmitter 22 of the electronic device 2 receives a connection signal transmitted by the remote controller 1, a microcontroller 21 stops audio frequency signals output by an output device 23, and the audio frequency signals are transmitted to the remote controller 1 via the wireless receiver/transmitter 22 to enable the remote controller 1 to output the audio frequency signals via the sound output device 3. When the control circuit 11 senses that the sound output device 3 is disconnected from the connection interface 131, the control circuit 11 transmits a disconnected signal to the electronic device 2 via the wireless receiver/transmitter 12 to stop the electronic device 2 form emitting the audio frequency signals to the remote controller 1 and restores the output device 23 connected to the electronic device 2 to output the audio frequency signals. Thus, the remote controller 1 of the present invention is capable of providing more convenience to the users.

According to an embodiment of the present invention, the digital/analog converter 13 may be further connected to a microphone.

The sound output device 3 may be a speaker or an earphone.

The buttons 11 of the remote controller 1 can control the electronic device 2 or a cursor in a monitor of the electronic device 2. Thus, the remote controller 1 is capable of controlling the electronic device 2 or the cursor in the monitor of the electronic device 2.

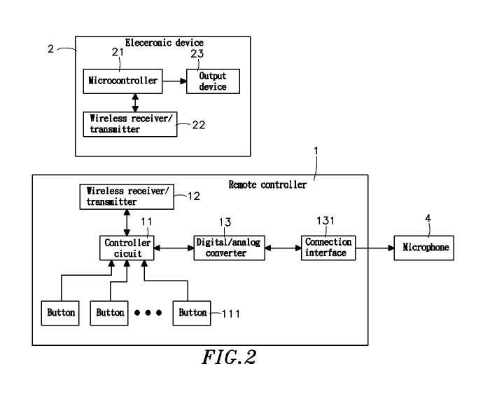

Referring to FIG. 2, when the digital/analog converter 13 is connected to a microphone 4, the microphone 4 is adopted for receiving sound signals and then the sound signals may be transmitted to the digital/analog converter 13 to convert the sound signals into digital signals and then transmit to the control circuit 11 and transmit to the electronic device 2 via the wireless receiver/transmitter 12, and finally output via the output device 23 connected to the electronic device 2.

Additionally, when the user presses the buttons 111 of the remote controller 1 to record, the remote controller 1 emits a recording signal to the electronic device 2, and the electronic device 2 continuously receives sound signals transmitted from the remote controller 1 and then stores the received sound signals.

Accordingly, the remote controller of the present invention has at least the following advantages.

1. When the control circuit senses the connection between the connection interface and the sound output device, the control circuit emits a connection signal via the wireless receiver/transmitter to the electronic device to enable the electronic device to continuously transmit audio frequency signals to the wireless receiver/transmitter of the remote controller via the wireless receiver/transmitter, and the wireless receiver/transmitter transmits the audio frequency signals to the digital/analog converter via the control circuit for converting the audio frequency signals into analog signals and output via the sound output device. Thus, the user can enjoy the audio frequency signal generated by the electronic device via the sound output device of the remote controller anywhere, and don't need to buy several electronic devices or turning the volume loud. Thus, the cost can be effectively reduced.

2. The wireless receiver/transmitter of the remote controller can receive the audio frequency signals generated from the electronic device within an effective range enable the user to enjoy the audio frequency signals outputted by the sound output device connected to the remote controller. Besides, a plurality of sound output devices may be connected to the remote controller and controlled by pressing the buttons connected to the controller circuit of the remote controller so that the user can use the remote controller to receive the audio frequency signals generated by the electronic device within the effective range and selectively output the audio frequency signals via the sound output devices.

3. A microphone may be connected the remote controller to receive and transmit the sound signals to the electronic device. Thus, this feature may add value to the remote controller of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A remote controller, comprising:
a sound output device;
a wireless receiver/transmitter, for receiving and transmitting audio frequency signals generated by an electronic device;
a digital/analog converter, electrically connected to said sound output device; and
a control circuit, electrically connected to said wireless receiver/transmitter, said digital/analog converter and a plurality of buttons respectively, for receiving and transmitting said audio frequency signals, wherein said buttons are adopted for generating control signals.

2. The remote controller as claimed in claim 1, wherein said digital/analog converter and said sound output device are connected via a connection interface.

3. The remote controller as claimed in claim 1, wherein said sound output device comprises an earphone.

4. The remote controller as claimed in claim 1, wherein said sound output device comprises a speaker.

5. The remote controller as claimed in claim 1, wherein said digital/analog converter is connected to a microphone.

6. The remote controller as claimed in claim 1, wherein further comprises a cursor-controlling device for controlling a cursor.

7. A remote controller, comprising:
a sound output device;
a wireless receiver/transmitter, for receiving and transmitting audio frequency signals generated by an electronic device;
a digital/analog converter, electrically connected to said sound output device; and
a control circuit, electrically connected to said wireless receiver/transmitter, said digital/analog converter and a plurality of buttons respectively, for receiving and transmitting said audio frequency signals, wherein said buttons are adopted for generating control signals, wherein when said digital/analog converter is connected to said sound output device, said control circuit emits a connection signal to said electronic device via said wireless receiver/transmitter, and when said electronic device receives said connection signal via a wireless receiver/transmitter of the electronic device, a microcontroller of said electronic device stops audio frequency signals from being outputted by an output device of the electronic device, and said audio frequency signals are continuously transmitted to said remote controller via said wireless receiver/transmitter of said electronic device to enable said remote controller to output the audio frequency signals via said sound output device.

8. The remote controller as claimed in claim 7, wherein said digital/analog converter and said sound output device are connected via a connection interface.

9. The remote controller as claimed in claim 7, wherein said sound output device comprises an earphone.

10. The remote controller as claimed in claim 7, wherein said sound output device comprises a speaker.

11. The remote controller as claimed in claim 7, wherein said digital/analog converter is connected to a microphone.

12. The remote controller as claimed in claim 7, wherein said remote controller comprises a cursor-controlling device for controlling a cursor.
